(19) United States
(12) Patent Application Publication
(10) Pub. No.: US 2003/0036045 A1
(43) Pub. Date: Feb. 20, 2003

(54) System and method for remotely accessing an educational course over a communications network

(76) Inventor: Kathryn B. Vivian, Pleasantville, NY (US)

Correspondence Address: Jennifer A. Albert, Esq., Hunton & Williams, Suite 1200, 1900 K Street, N.W., Washington, DC, 20006, US

(21) Appl. No.: 09/930,248

(22) Filed: Aug. 16, 2001

(51) Int. Cl. G09B 3/00

(52) U.S. Cl. 434/350

(57) ABSTRACT

A system and method of remotely accessing an educational course comprised of a plurality of educational modules stored in a database server is provided that allow a user to download an educational module into a handheld device, such as a Palm Pilot™. The educational modules are downloaded at a time when the user can establish a communication link with the database server that contains the educational modules. Because the educational modules are downloaded into memory of the handheld device, the educational modules can be read at a time that is convenient to the user without having to establish a communication link with the database server.

### BACKGROUND OF THE INVENTION

This invention relates to educational courses and, more particularly, to a system and method for providing remote access to an educational course over a communications network.

One area for which the Internet is well suited is education. Offering educational courses online is becoming more common as the number of Internet users increase, and the cost of the equipment necessary to access the Internet decreases.

However, in our increasingly mobile society, it is becoming more difficult to stay connected to Internet-based services. Handheld devices, such as a Palm Pilot™, are becoming increasingly popular for organizing and integrating personal and business information. An increase in the number of applications available for these devices, as well as their small size, are some of the reasons that these handheld devices have become so popular.

However, access to the Internet via such handheld devices is still quite limited. Wireless Internet service is cost prohibitive for many users, and is currently only offered in major metropolitan areas. Thus, accessing Internet content, such as educational courses, while outside the office or the home is still not possible for many users.

### SUMMARY OF THE INVENTION

Thus, in order to overcome the aforesaid deficiencies and others, in an exemplary embodiment of the invention, a method of remotely accessing an educational course stored on a database comprises the steps of downloading, onto a handheld device, at least one portion of the educational course from the database at a time when the handheld device can establish a communication link with the database, and storing the portion of the educational course on the handheld device for viewing at a time chosen by a user of the handheld device.

The invention also provides a system for providing remote access to an educational course, comprising a handheld device, and a server that stores the educational course as a plurality of educational modules readable and storable on the handheld device, wherein the server is configured to transfer at least one of the educational modules to the handheld device through a communication link initiated by the handheld device.

The system and method of the invention allow a user to download an educational module into a handheld device, such as a Palm Pilot™, for viewing at a time of his/her choosing, e.g., on a bus or train trip for a commuter, while waiting in a car to pick someone up, or while waiting in a doctor's office. The educational module is downloaded at a time when the user can establish a communication link with a server. Because the educational module is stored on the handheld device, the educational module can be read at a time that is convenient to the user without having to worry about establishing a communication link with the server.

### BRIEF DESCRIPTION OF THE DRAWINGS

FIG. 1 is a schematic diagram of a system for providing remote access to an educational course, in accordance with one embodiment of the present invention;

FIG. 2 is a schematic diagram of a system for providing remote access to an educational course in accordance with another embodiment of the present invention;

FIG. 3 is a flowchart illustrating steps in a method of distributing an educational course in accordance with one embodiment of the present invention;

FIG. 4 is a flowchart illustrating steps in a method of providing remote access to an educational course in accordance with one embodiment of the present invention;

FIG. 5 is a flowchart illustrating steps in a preferred method for implementing the transfer step in the method of FIG. 4;

FIG. 6 is a flowchart illustrating steps in a method of remotely accessing an educational course with a handheld device in accordance with one embodiment of the present invention; and

FIG. 7 is a flowchart illustrating step in a preferred method for implementing the receiving step in the method of FIG. 6.

### DETAILED DESCRIPTION OF THE INVENTION

Reference will now be made in detail to exemplary embodiments of the invention, examples of which are illustrated in the accompanying drawings in which like reference characters refer to corresponding elements.

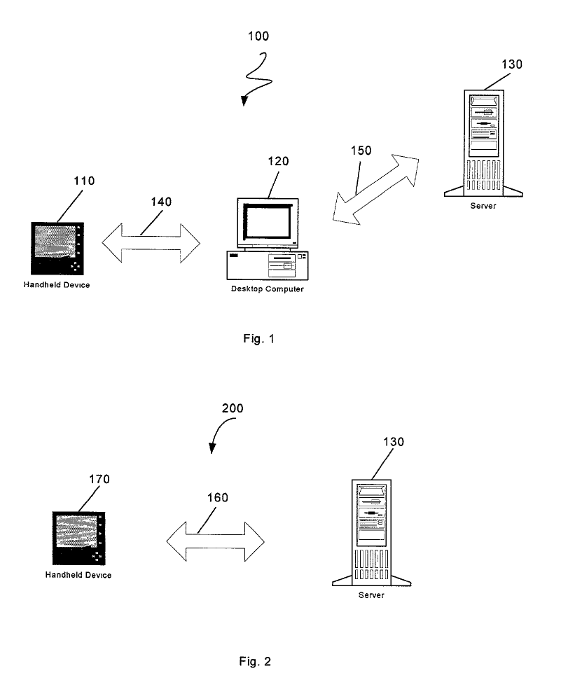

FIG. 1 shows a system 100 for providing remote access to an educational course, in accordance with one embodiment of the present invention. The system 100 includes a handheld device 110, a desktop computer 120 and a server 130.

The server 130 includes a database that stores an educational course as a plurality of educational modules that are readable by and storable on the handheld device 110. The handheld device 110 is suitably a personal digital assistant (PDA), such as a Palm Pilot™ organizer. The handheld device 110 is designed to synchronize with the desktop computer 120 via a communication link 140. The handheld device 110 typically includes a plurality of personal information managers (PIMs) such as a calendar, a “to do” list, and a contact list. These PIMs are also generally stored on the desktop computer 120. When the handheld device 110 and the desktop computer 120 are synchronized utilizing a synchronization procedure, the PIMs on both the handheld device 110 and the desktop computer 120 are reconciled. For example, if a new calendar entry is made in the handheld device 110, upon synchronization, the new calendar entry is made in a calendar stored on the desktop computer 120.

The handheld device 110 is programmed to store and read the educational modules stored on the server 130. In the system 100 of FIG. 1, when the handheld device 110 is synchronized with the desktop computer 120, the desktop computer 120 establishes a communication link 150 with the server 130 and downloads at least one of the educational modules. The downloaded educational module is then transferred to the handheld device 110 during the synchronization procedure using the communication link 140.

Before an educational module is downloaded to the handheld device 110, it will generally be necessary to establish an account with a service providing the educational course. This can be accomplished by logging onto the server 130 via the communication link 150 using the desktop computer 120 and providing any information necessary to establish an account with the service providing the educational course. Alternatively, the handheld device 110 can be programmed to accept information necessary to establish an account, and transfer this information to the server 130 via the communication links 140 and 150 when the handheld device 110 is synchronized with the desktop computer 120.

FIG. 2 shows a system 200 for providing remote access to an educational course, in accordance with another embodiment of the present invention. The system 200 includes a handheld device 170 and a server 130. The system 200 is similar to the system 100 of FIG. 1, except that the system 200 of FIG. 2 is designed so that the handheld device 170 communicates directly with the server 130 via a direct communication link 160.

To accomplish this, the handheld device 170 includes any necessary hardware and is programmed with any necessary software to establish the direct communication link 160 with the server 130, such as would be known to persons of ordinary skill in this field. For example, the handheld device 170 can incorporate a wired or a wireless modem and any associated software for establishing the direct communication link 160 with the server 130. In operation, the handheld device 170 establishes the communication link 160 with the server 130 and downloads the desired educational modules from the server 130. The educational modules are then stored on the handheld device 170 for later viewing by a user.

As discussed above, the educational course is broken into a plurality of individual educational modules that are sufficiently small in size in terms of a number of data bytes to be stored on a handheld device 110 or 170 without taking up an excessive amount of the memory available in the handheld device 110 or 170. For example, each individual educational module can be designed to be a stand-alone module that can be read in approximately 5 minutes.

Additionally, the plurality of the educational modules can be designed to be read in a predetermined order representing a series of educational modules. In this configuration, the software on the handheld device 110 or 170 is configured to detect when a currently stored educational module has been read. Then, when the handheld device 110 or 170 establishes another communication link 160 with the server 130, the handheld device 110 or 170 may transmit a signal indicative of a next one or a current one of the educational modules stored in memory of the handheld device 110 or 170. The server 130 will then transfer a next educational module in the series of educational modules to the handheld device 110 or 170. Alternatively, the server 130 may store data indicative of the current one or the next one of the educational modules to be downloaded to the handheld device 110 or 170 and may automatically transmit the next one of the educational modules upon detection that the handheld device 110 or 170 has established the communication link 160.

The educational modules can be designed to be interactive with the user. For example, an educational module can include a plurality of questions for the user to answer using the handheld device 110 or 170. The user can review the educational module and can then test how well he/she understood a topic described in the educational module by responding to each of the plurality of questions. The user can respond to each of the questions by depressing a button on the handheld device 110 or 170, for example. Upon input of an answer to a question, the input answer can be stored in the memory of the handheld device 110 or 170. The input answers can then be transferred to the server 130 the next time a communication link 160 is established between the handheld device 110, 170 and the server 130. The server 130 may have a master list of answers to the questions in the educational module. A comparison can be conducted comparing each of the user's answers to the plurality of questions to each of the answers on the master list and a score can be assessed for the user based on a number of correct answers. Alternatively, each educational module could be designed to include the questions and corresponding answers and the user could compare his/her answer to the corresponding answer stored within the educational module for a more instantaneous assessment of his/her comprehension of the topic contained in the educational module.

An educational course on any topic can be designed as a series of educational modules, as explained above, and can be stored on the server 130 for remote access by the handheld device 110 or 170. For example, a financial course, such as a course on retirement planning, estate planning, managing taxes, building a financial plan, etc, can be modularized and stored on the server 130.

The communication links 140, 150 and 160 can be wired or wireless links, and may include or interface to any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34 bis analog modem connection, a cable modem, an Asynchronous Transfer Mode (ATM) connection, a Fiber Distributed Data Interface (FDDI) or a Copper Distributed Data Interface (CDDI) connection. The communication links 140, 150 and 160 may also include or interface to any one or more of a Wireless Application Protocol (WAP) link, a General Packet Radio Service (GPRS) link, a Global System for Mobile Communication (GSM) link, a Code Division Multiple Access (CDMA) or a Time Division Multiple Access (TDMA) link such as a cellular phone channel, a Global Positioning System (GPS) link, a cellular digital packet data (CDPD) link, a Research in Motion (RIM) limited duplex paging type device, a Bluetooth radio link, or an IEEE 802.11-based radio frequency link. The communication links 140, 150 and 160 may further include or interface to any one or more of an RS-232 serial connection, an IEEE-1394 Firewire connection, a Fibre Channel connection, an infrared (IrDA) port, a Small Computer Systems Interface (SCSI) connection, a Universal Serial Bus (USB) connection or another wired or wireless, digital or analog interface or connection.

The desktop computer 120 may include, for instance, a workstation running a Microsoft Windows™ NT™, a Windows™ 2000, a Unix, a Linux, a Xenix, an IBM AIX™, a Hewlett-Packard UX™, a Novell Netware™, a Sun Microsystems Solaris™, an OS/2™, a BeOS™, a MacIntosh, an Apache, or an OpenStep™ operating system or another operating system or platform.

The handheld device 110 or 170 may comprised of a Palm Pilot™ organizer, a Compaq iPaq™ pocketPC™, an HP Jornada™ device or any other handheld computer or organizer.

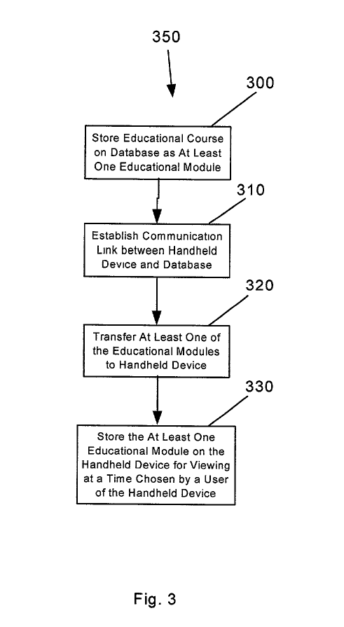

FIG. 3 is a flow chart illustrating a plurality of steps in a method 350 for distributing an educational course in accordance with one embodiment of the present invention. The method 350 starts at step 300, where an educational course comprised of at least one educational module is stored on a database. The method 350 then continues to step 310, where a communication link is established between a handheld device and the database.

At step 320, the at least one educational module is transferred to the handheld device. The method 350 then proceeds to step 330, where the educational module is stored on the handheld device for viewing at a time chosen by a user of the handheld device.

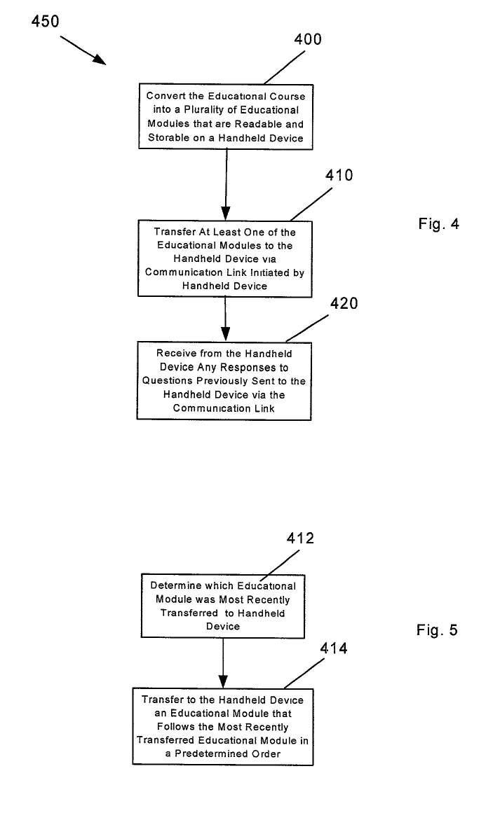

FIG. 4 is a flowchart illustrating a plurality of steps in a method 450 of providing remote access to an educational course stored in a database on a remote server in accordance with one embodiment of the present invention. Method 450 starts at step 400, where the educational course is converted into a plurality of educational modules that are readable and storable on a handheld device. Each of the plurality of educational modules may include a plurality of questions therein.

Next at step 410, at least one of the educational modules is transferred from the database to the handheld device via a communication link between the server and the handheld device. The transfer may be initiated by the handheld device. The user can review a topic contained in the educational module and can test his/her comprehension of the topic by conducting a self-test and answering a plurality of questions contained in the educational module in the manner discussed above. The user's answer to each question can be stored within the memory of the handheld device. The method 450 then proceeds to step 420, where the database receives adata transmission from the handheld device, via the communication link, including any answers to questions stored in the memory of the handheld device.

FIG. 5 is a flowchart illustrating a plurality of steps in a method of implementing the transfer step 410 of FIG. 4, when the plurality of educational modules are designed to be viewed in a predetermined order as a series. The method begins at step 412, where the server determines which one of the plurality of educational modules was most recently transferred to the handheld device. Then, at step 414, the server transfers to the handheld device an educational module that follows the most recently transferred educational module in the predetermined order.

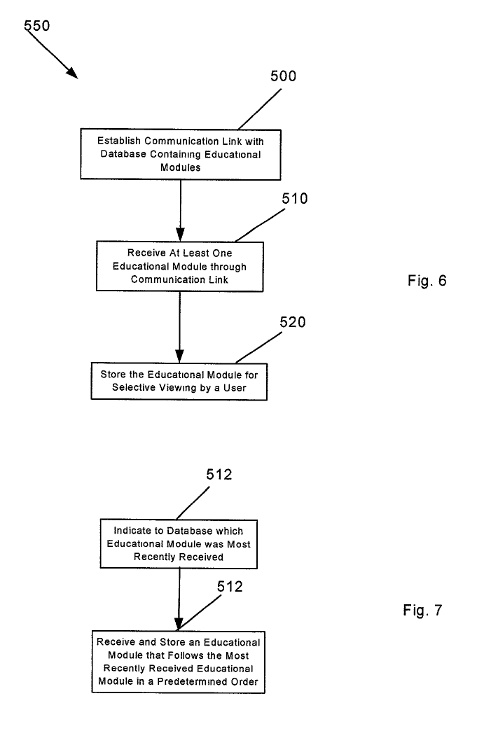

FIG. 6 is a flowchart illustrating a plurality of steps in a method 550 of remotely accessing an educational course with a handheld device, in accordance with one embodiment of the present invention. The method 550 starts at step 500, where the handheld device establishes a communication link with the database containing the educational modules.

The method 550 then proceeds to step 510 where the handheld device receives at least one educational module through the communication link established with the database. Next, at step 520 the handheld device stores the educational module for selective viewing by a user of the handheld device.

FIG. 7 is a flowchart illustrating a plurality of steps in a method 600 of implementing the receiving step 510 of FIG. 6, when the plurality of educational modules are designed to be viewed in a predetermined order as a series. The method 600 starts at step 512, where the handheld device transmits a signal to the database indicating to the database which one of the plurality of educational modules was most recently received by transmission from the database to the handheld device. Then, at step 514, the handheld device receives and stores an educational module that follows the most recently received educational module in the predetermined order.

The system and method of the present invention allow a user to download an educational module at a time when he/she can establish a communication link with a database that contains the educational modules, and can then view the educational module at a time that is convenient for him/her. Because each of the educational courses are broken up into small educational modules, they can be viewed with handheld devices that have limited processing power and memory. Thus, the system and method of the present invention provide a mobile individual with an ability to access educational courses without having to carry cumbersome laptop computers. Because an educational module may be stored on the handheld device for later viewing by the user, the user does not have to worry about establishing a communication link with a content provider offering the educational course while he/she is away from his/her home or office.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method of remotely accessing an educational course stored on a database, comprising the steps of:
downloading, onto a handheld device, at least one portion of the educational course from the database at a time when the handheld device can establish a communication link with the database; and
storing the at least one portion of the educational course on the handheld device for viewing at a time chosen by a user of the handheld device.

2. The method of claim 1, wherein the downloading step comprises:
establishing the communication link between the handheld device and the database; and
transferring the least one portion of the educational course to the handheld device through the communication link.

3. The method of claim 2, wherein the communication link comprises an Internet connection.

4. The method of claim 2, wherein the communication link comprises a wireless connection.

5. The method of claim 1, wherein the database is stored on an Internet server.

6. The method of claim 1, wherein the at least one portion of the educational course is viewable by the user of the handheld device while the handheld device is not in communication with the database.

7. The method of claim 2, wherein the step of establishing a communication link between the handheld device and the database comprises:
establishing a communication link between a personal computer and the database; and
establishing a connection between the handheld device and the personal computer.

8. The method of claim 7, wherein the personal computer comprises a desktop computer.

9. The method of claim 7, wherein the personal computer comprises a laptop computer.

10. The method of claim 7, wherein the connection between the handheld device and the personal computer comprises a local area network link.

11. The method of claim 7, wherein the connection between the handheld device and the personal computer comprises a modem connection.

12. The method of claim 7, wherein the connection between the handheld device and the personal computer comprises a wireless connection.

13. The method of claim 1, wherein the downloading step comprises downloading to the handheld device at least one portion of the educational course that has not been previously downloaded to the handheld device.

14. The method of claim 13, further comprising the step of deleting a previously transferred portion of the educational course from the handheld device if the previously transferred portion of the educational course has been viewed by the user of the handheld device.

15. The method of claim 1, wherein the educational course comprises a financial course.

16. The method of claim 1, wherein the at least one downloaded portion of the educational course comprises a plurality of questions for the user to answer.

17. The method of claim 16, further comprising the steps of:
determining a response to each of the questions;
storing the responses on the handheld device; and
transferring the responses to a remote location.

18. The method of claim 17, wherein the responses are transferred to the database at a time when the handheld device can establish a communication link with the database.

19. The method of claim 1, wherein the at least one transferred portion of the educational course comprises audiovisual information.

20. The method of claim 1, wherein the handheld device comprises a handheld computer.

21. The method of claim 1, wherein the handheld device comprises a personal digital assistant.

22. A method of providing remote access to an educational course, comprising the steps of:
converting the educational course into a plurality of educational modules that are readable by and storable on a handheld device; and
transferring at least one of the educational modules to the handheld device through a communication link initiated by the handheld device, wherein the at least one transferred educational module is selectively viewable by a user.

23. The method of claim 22, wherein the step of transferring the at least one of the educational modules to the handheld device comprises the steps of:
determining which one or more of the plurality of educational modules has previously been transferred to the handheld device; and
transferring to the handheld device at least one educational module that has not been previously transferred to the handheld device.

24. The method of claim 22, wherein the plurality of educational modules are adapted to be viewed by a user in a predetermined order.

25. The method of claim 24, wherein the step of transferring the at least one of the educational modules to the handheld device comprises the steps of:
determining which one of the educational modules was most recently transferred to the handheld device; and
transferring to the handheld device an educational module that follows the most recently transferred educational module in the predetermined order.

26. The method of claim 22, wherein the communication link comprises an Internet connection.

27. The method of claim 22, wherein the communication link comprises a wireless connection.

28. The method of claim 22, wherein the educational modules are stored on a web server.

29. The method of claim 22, wherein the educational course comprises a financial course.

30. The method of claim 22, wherein at least one of the transferred educational modules comprises questions for a user to answer.

31. The method of claim 30, further comprising the step of receiving responses to the questions transferred to the handheld device through another communication link initiated by the handheld device.

32. The method of claim 22, wherein at least one of the transferred educational modules comprises audiovisual information.

33. The method of claim 22, wherein the handheld device comprises a handheld computer.

34. The method of claim 22, wherein the handheld device comprises a personal digital assistant.

35. A method of remotely accessing an educational course with a handheld device, comprising the steps of:
establishing a communication link between the handheld device and a database containing the educational course, wherein the educational course comprises a plurality of educational modules that are readable and storable on the handheld device;
receiving at least one of the educational modules through the communication link; and
storing the at least one educational module on the handheld device for selective viewing by a user of the handheld device.

36. The method of claim 35, wherein the steps of receiving and storing the at least one of the educational modules on the handheld device comprise:
determining which of the educational modules have not been previously received and stored on the handheld device; and
receiving at least one educational module that has not been previously received and stored on the handheld device.

37. The method of claim 35, wherein the plurality of educational modules are adapted to be viewed by the user in a predetermined order.

38. The method of claim 37, wherein the steps of receiving and storing the at least one of the educational modules on the handheld device comprises:
determining which of the educational modules was most recently received and stored on the handheld device; and
receiving and storing on the handheld device an educational module that follows the most recently received and stored educational module in the predetermined order.

39. The method of claim 35, wherein the step of establishing a communication link comprises establishing an internet connection.

40. The method of claim 35, wherein the step of establishing a communication link comprises establishing a wireless connection.

41. The method of claim 35, wherein the database containing the educational course is stored on a web server.

42. The method of claim 35, wherein the educational course comprises a financial course.

43. The method of claim 35, wherein at least one of the received educational modules comprises questions for the user to answer.

44. The method of claim 43, further comprising the steps of:
determining responses to the questions;
storing the responses on the handheld device; and
transferring the responses to a remote location through another communication link established between the handheld device and the database.

45. The method of claim 44, wherein the responses are transferred to the database.

46. The method of claim 35, wherein at least one of the received educational modules comprises audiovisual information.

47. The method of claim 35, wherein the handheld device comprises a handheld computer.

48. The method of claim 35, wherein the handheld device comprises a personal digital assistant.

49. A system for providing remote access to an educational course, comprising:
a handheld device; and
a server that stores the educational course as a plurality of educational modules readable by and storable on the handheld device,
wherein the server is configured to transfer at least one of the educational modules to the handheld device through a communication link initiated by the handheld device.

50. The system of claim 49, wherein, when the communication link is initiated by the handheld device, the server determines which of the educational modules have not been previously transferred to the handheld device, and transfers to the handheld device at least one educational module that has not been previously transferred to the handheld device.

51. The system of claim 49, wherein the plurality of educational modules are adapted to be viewed by a user in a predetermined order.

52. The system of claim 51, wherein the server determines which of the educational modules was most recently transferred to the handheld device through a previous communication link, and transfers to the handheld device an educational module that follows, in the predetermined order, the most recently transferred educational module.

53. The system of claim 49, wherein the communication link initiated by the handheld device comprises an internet connection.

54. The system of claim 49, wherein the communication link initiated by the handheld device comprises a wireless connection.

55. The system of claim 49, wherein the educational course comprises a financial course.

56. The system of claim 49, wherein at least one of the educational modules transferred by the server comprises questions for a user to answer.

57. The system of claim 56, the server is configured to receive responses to the questions transferred to the handheld device through another communication link initiated by the handheld device.

58. The system of claim 49, wherein at least one of the educational modules transferred by the server comprises audiovisual information.

59. The system of claim 49, wherein the handheld device comprises a personal digital assistant.

60. The system of claim 49, wherein the handheld device comprises a handheld computer.
